(19) United States
(12) Patent Application Publication
(10) Pub. No.: US 2008/0159144 A1
(43) Pub. Date: Jul. 3, 2008

(54) QUALITY OF SERVICE AWARE ROUTING OVER MOBILE AD HOC NETWORKS (MANETS)

(75) Inventors: Ramesh Nagarajan, Princeton, NJ (US); Shyam P. Parekh, Orinda, CA (US); Kiran M. Rege, Marlboro, NJ (US)

Correspondence Address: SYNNESTVEDT & LECHNER, LLP, 1101 MARKET STREET, SUITE 2600, PHILADELPHIA, PA, 19107-2950, US

(73) Assignee: LUCENT TECHNOLOGIES INC., Murray Hill, NJ (US)

(21) Appl. No.: 11/617,876

(22) Filed: Dec. 29, 2006

(51) Int. Cl. G08C 15/00

(52) U.S. Cl. 370/235

(57) ABSTRACT

The present invention provides a method and apparatus for routing a data flow from a source node to a destination node in a mobile ad-hoc network (MANET). The present invention performs this function by first determining desired service requirements for an individual data flow to be forwarded to a destination node. Next, the present invention broadcasts an advertisement for each of the links in the MANET by the corresponding origination nodes, the advertisement including a value indicating the current performance level of the link. After broadcasting the advertisements, routing tables are composed at each of the nodes based upon the advertisements. Each routing table is constructed taking into account the advertised links and their corresponding values. After composing the routing tables, packets are forwarded toward their respective destinations by utilizing the routing tables in such a manner that the desired service requirements are satisfied.

### FIELD OF THE INVENTION

The invention pertains to packet routing over Mobile Ad Hoc Networks (MANETs).

### BACKGROUND OF THE INVENTION

A MANET is a highly dynamic and constantly evolving network in which a collection of wireless mobile nodes form a network without any fixed infrastructure. A MANET is useful in a situation in which it is economically or physically impractical to provide a fixed infrastructure, such as for emergency workers during a hurricane or for soldiers on a battlefield. Such conditions provide no opportunity for a permanent infrastructure, which makes the mobile aspect of a MANET ideal. Efficient routing over MANETs has been a focus of research in recent years.

Quality of service (QoS) requirements of MANETs have also been a focus of research in the data networking community as interest in real-time applications over minimal infrastructure networks, such as MANETs, has increased. One specific application where QoS is of particular concern is voice over IP (VoIP). VoIP is essentially telephone service over the Internet, i.e., utilizing a data network connection to make real time telephone calls. In the two above situations, utilizing a MANET to carry VoIP data flows is beneficial as it provides contact to soldiers or emergency workers who may be far from a fixed contact point. By utilizing nodes in the MANET, the VoIP data flow can be routed to its destination despite the lack of a permanent communication infrastructure.

One popular routing protocol for MANETs is the Optimized Link State Routing (OLSR) protocol. OLSR is explained in “Optimized Link State Routing Protocol (OLSR)” by Clausen & Jacquet, RFC 3626, published October 2003, and available on the internet at “http://ietf.org/rfc/rfc3626.txt”. In a MANET, a link is any outgoing path from an individual node to another node. OLSR is a proactive routing protocol that propagates partial link state information through a MANET to support hop-by-hop packet forwarding based on the “min-hop” criterion. “Min-hop” essentially means minimum hop, or selecting a route based on the fewest hops between source and destination, regardless of the quality of the links used for each hop. Note that as long as a link is considered alive, as determined, for example, by the reception of a minimum number of hello messages in some time period, the OLSR protocol advertises it and uses it in the construction of routing tables, regardless of the quality of that link. Thus, during some topology changes, for instance, a link may go through long periods of low link quality before being considered “dead.” Any source node utilizing this advertised weak link in its routing tables risks packet delays and packet losses, both of which cause degradation to the data flow. In the above case where a MANET is used to carry a VoIP data flow, excessive packet delays and packet losses may cause an individual VoIP data flow to be completely lost.

The basic algorithm underlying routing table calculations in OLSR attempts to minimize path lengths between source-destination pairs by selecting routes with the smallest number of hops between source and destination nodes without concern for link quality. What is needed is a method of determining any desired service requirements for a data flow being forwarded in a MANET before determining a route to use for forwarding the data flow.

### SUMMARY OF THE INVENTION

The present invention provides a method of improving on the OLSR routing protocol to not only look for a “min-hop” route, but to look for paths with good delay characteristics for non-real time (or best effort) traffic (e.g., email attachments) as well as good link quality characteristics for real time traffic (e.g., streaming audio or video). The present invention modifies the routing table calculation of the OLSR protocol to utilize a calculated delay metric to evaluate links in the routing table and choose an appropriate route based upon the QoS level required by a data flow being forwarded along the chosen route.

In order to determine which criteria to use when selecting a route, the data flow being forwarded must first be analyzed to determine a minimum QoS level that must be maintained along the selected route. By utilizing extension headers (such as those defined by IP version 6), desired service parameters (e.g., necessary bandwidth, acceptable delays) are included in the first packet of the data flow. By analyzing these parameters, a source node can determine a route with intermediate nodes that have adequate resources to deliver the data flow. Once the route is determined by the source node, the data flow is forwarded along the route to a destination node.

In one embodiment of the present invention, the service requirements for a particular data flow are determined, as well as the type of the data flow, i.e., best-effort traffic or real-time traffic. Once the requirements of the data flow are determined, a source node uses routing tables to select a route to a destination node that will satisfy the service requirements.

For best effort traffic, a route is selected that will minimize the hops between the source node and the destination node. For real-time traffic, the desired service requirements are written into an extension header of the first packet of the data flow. The first packet is delivered to the Internet Protocol (IP) layer of the source node where the extension header is read. The desired service requirements are analyzed, and a route cache is checked. The route cache stores routes previously used to forward data flows to certain nodes. If a route exists in the route cache that will satisfy the desired service requirements, the route is inserted into an additional extension header in the first packet of the data flow, and the packet (along with the rest of the data flow) is forwarded along the chosen route.

If a route does not exist in the route cache, the source node utilizes the network routing tables to construct a new route, which as before is inserted in an additional extension header in the first packet, and the packet is forwarded along the route. The new route is also stored in the route cache for later use.

### BRIEF DESCRIPTION OF THE DRAWINGS

FIG. 1 is a block diagram illustrating a MANET.

FIG. 2 is a flow chart illustrating the configuration of a MANET according to one embodiment of the present invention.

FIG. 3 is a flow chart illustrating forwarding a packet through a MANET according to one embodiment of the present invention.

### DETAILED DESCRIPTION OF THE INVENTION

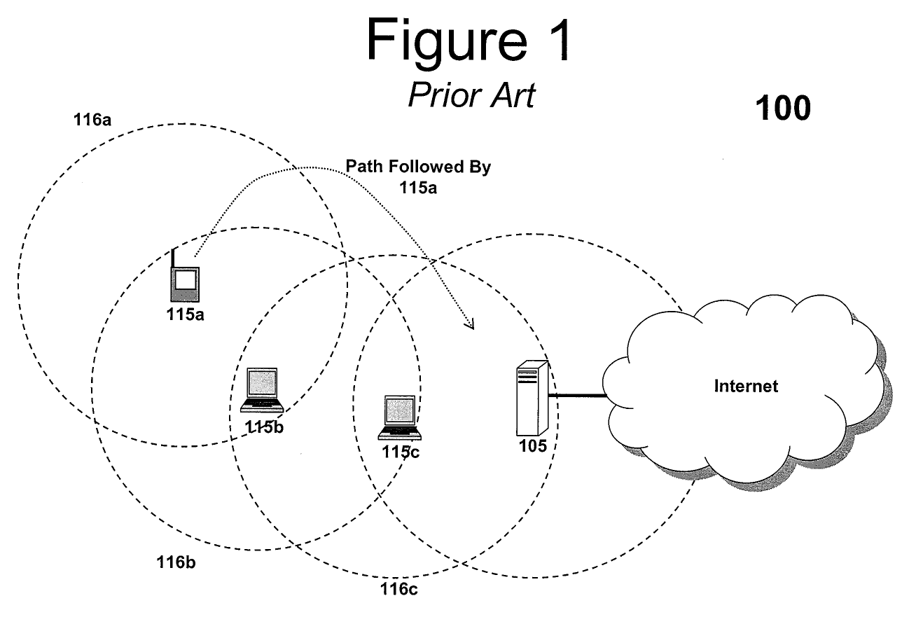

MANETs are highly dynamic, with frequent topology changes as nodes move into or out of the transmission range of other nodes. FIG. 1 illustrates MANET. Here, MANET 100 is used by mobile devices to communicate with one another and to access the Internet 107. Gateway 105 allows nodes, i.e., mobile devices, in MANET 100 to access the Internet 107.

A MANET predominantly comprises mobile devices, e.g., 115a, 115b and 115c as shown in FIG. 1. In this example, 115a is a personal digital assistance (PDA) while 115b and 115c are laptop computers. The mobile devices 115a, 115b and 115c are nodes of MANET 100. However, one feature that distinguishes a MANET from a typical wireless network, e.g., a wireless LAN, is that, in a MANET, each node acts as a source or destination of data as well as a router. Mobile devices can directly communicate with one another if they are within each other's transmission range 116; otherwise, communications between them follow a multi-hop path where data packets originating at the source node are received at intermediate nodes and then forwarded toward the destination by the intermediate nodes on the path between the source and the destination nodes. For instance, in FIG. 1, nodes 115a and 115c are not within each other's transmission range 116a and 116c. As a consequence, if node 115a wishes to communicate with node 115c, it sends its data packets to node 115b, which is within node 115a's transmission range 116a; node 115b receives these packets and transmits them to node 115c which is in its, node 115b's, transmission range 116b. As mentioned before, communications between nodes in MANET 100 and servers and devices in the Internet 107 pass through the Gateway 105. Communications between nodes of MANET 100 do not involve Gateway 105. Note that a stand-alone MANET, where the nodes communicate with one another only and not with external devices, need not include a Gateway such as the Internet Gateway 105 shown in FIG. 1.

In a realistic MANET, hundreds or thousands of nodes may be present. A remote node may have numerous links to use to connect to another node, or an Internet Gateway such as 105 in FIG. 1. Typical routing techniques utilize a minimum hop routing protocol, where a source-destination route is chosen based upon the smallest number of hops, or intermediate nodes, between the source and destination nodes. This technique ignores the current conditions of the network such as individual link traffic and overall performance of individual nodes.

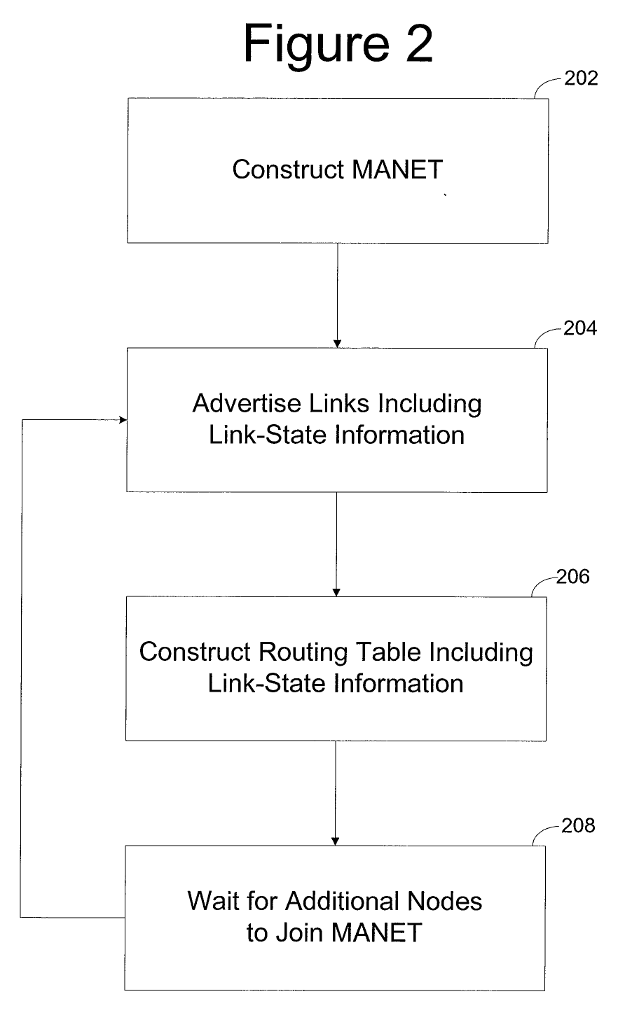

FIG. 2 illustrates a flow diagram showing one configuration procedure for a MANET according to one embodiment of the present invention. The process begins at step 202 when the actual MANET is formed. As discussed above with respect to FIG. 1, this involves grouping individual devices into an organized network structure. Once the individual devices are organized into nodes of the MANET, the process moves to step 204.

At step 204, each of the now organized nodes advertises its link-state information. By using standard OLSR mechanisms, e.g., hello messages and topology control (TC) messages, link-state information is propagated through the MANET. The hello messages and TC messages are augmented to carry additional information such as available link bandwidth, signal-to-noise (SNR) and delay information for each link. Once the nodes advertise their link-state information, the process proceeds to step 206.

At step 206, each node constructs an initial routing table based upon the information contained in the hello messages. The standard OLSR routing tables are augmented to include the additional information contained in the hello and TC messages, specifically the link-state information. Once the nodes have created the initial routing table, the process proceeds to step 208.

At step 208, additional nodes can join the MANET. When a new node joins the MANET, the process returns to step 204 where the process repeats resulting in updated routing tables at each node in the MANET.

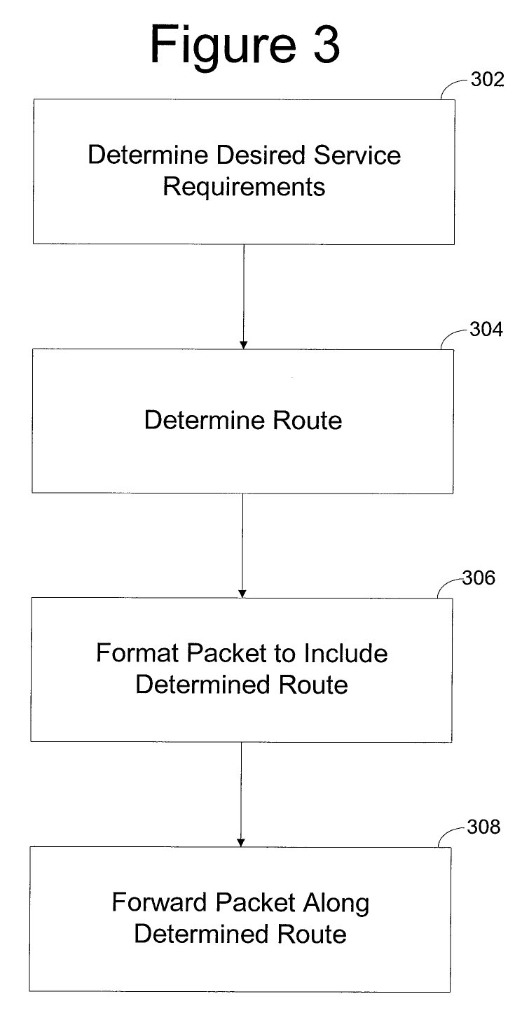

Once the MANET is configured, each node utilizes the routing tables to forward data from one node to another. FIG. 3 illustrates a flow diagram of the steps taken by individual nodes to forward a data flow from a source node to a destination node. The process begins at step 302. Here, a source node determines the type of data to be forwarded to the destination node, specifically whether the data is best-effort traffic, e.g., an email attachment or word processing document; or real time traffic, e.g., a VoIP phone call or a streaming video. If the data is real-time traffic, the source node also determines any desired service requirements such as desired bandwidth, delay and packet loss probability.

Once a source node has determined the type of data being sent as well as any accompanying service requirements, the process moves to step 304. Here, the source node determines a route to the destination node. First, the source node looks into its route cache where all routes previously used by the source node for forwarding packets are stored. If a route exists in the route cache that satisfies the desired service requirements, the source node selects that route. If no such route exists in the route cache, the source node creates a new route to the destination node based upon the information stored in the routing tables for the MANET created in step 206 of FIG. 2. By utilizing the additional information stored in the route tables relating to the current performance levels of the nodes of the MANET, the source node can determine a route to the destination node that satisfies the desired service requirements. Once a route is determined, the process proceeds to step 306.

At step 306, the source node formats the initial packet of the data to be sent. An extension header is added to the packet which includes the desired service requirements. A second extension header is added which includes the entire route determined by the source node to be used in forwarding the data to the destination node. Once the packet is formatted, the process proceeds to step 308.

At step 308, the source node forwards the packets of the data flow along the determined route to the destination node.

The embodiment shown in FIG. 3 is merely shown as an example of the principles of the present invention. It should be clear to one of ordinary skill in the art that additional embodiments are not fully illustrated in FIG. 3. For example, step 304 can include additional information relating to the creation of a new route. Multiple objectives can be considered when a source route creates a new route. For example, the following two criteria can be used in route creation:
1. Minimizing the route length under delay and bandwidth constraints. Essentially, find a path to the destination node such that the sum of any delays on the route is within the desired service requirements. Similarly, the available bandwidth on the route is within the desired service requirements.
2. Minimize the route length under bandwidth constraints while only using links that have a signal quality above a predetermined threshold, thereby satisfying the desired service requirements.

It should be clear to persons familiar with the related arts that the processes, procedures and/or steps of the invention described herein can be performed by a programmed computing device running software designed to cause the computing device to perform the processes, procedures and/or steps described herein. These processes, procedures and/or steps also could be performed by other forms of circuitry including, but not limited to, application-specific integrated circuits, logic circuits and state machines.

The embodiments shown above are merely shown by way of example. One of ordinary skill in the art will recognize additional embodiments and advantages not fully illustrated above. For example, different desired service requirements can be selected to identify a particular data flow. Accordingly, the breadth and scope of the present invention should be defined only in accordance with the following claims and their equivalents.

1. A method for routing data from a source node to a destination node in a mobile ad-hoc network (MANET) comprising a plurality of mobile nodes and a plurality of links between nodes of said MANET, the method comprising the steps of:
determining desired service requirements for said data;
determining a quantitative value for each link at a node where the link originates in said MANET;
broadcasting an advertisement for each of said links in said MANET by each of said nodes, said advertisement including said value;
composing a routing table at each of said nodes based upon said value; and
forwarding packets from said source node to said destination node in accordance with said routing table such that a route selected from said routing tables satisfies said desired service requirements.

2. The method of claim 1, wherein said desired service requirements comprise bandwidth, delay and packet loss probability.

3. The method of claim 1, wherein said value comprises available bandwidth, delay and signal quality at each node.

4. The method of claim 1, wherein said data is a voice over IP (VoIP) data flow.

5. The method of claim 1, wherein said value represents a performance level of an entire node.

6. The method of claim 1, wherein said value represents a performance level of an individual link.

7. A method for routing data from a source node to a destination node in a mobile ad-hoc network (MANET) comprising a plurality of nodes and a plurality of links between nodes of said MANET, the method comprising the steps of:
means for determining desired service requirements for said data at said source node;
each of said nodes in said MANET advertising each of said links, said advertisement including a determined value;
each of said nodes composing a routing table based upon said advertisements, said routing table including said advertised value; and
forwarding packets belonging from said source node to said destination node in accordance with said routing table such that a selected route satisfies the desired service requirements.

8. The method of claim 7, wherein data is a VoIP data flow.

9. A system for routing data from a source node to a destination node in a mobile ad-hoc network (MANET) comprising a plurality of mobile nodes and a plurality of links between nodes of said MANET, the system comprising:
means for determining desired service requirements for said data;
means for determining a quantitative value for each link at a node where the link originates in said MANET;
means for broadcasting an advertisement for each of said links in said MANET by each of said nodes, said advertisement including said value;
means for composing a routing table at each of said nodes based upon said value; and
means for forwarding packets from said source node to said destination node in accordance with said routing table such that a route selected from said routing tables satisfies said desired service requirements.

10. The system of claim 9, wherein said desired service requirements comprise bandwidth, delay and packet loss probability.

11. The system of claim 9, wherein said value comprises available bandwidth, delay and signal quality at each node.

12. The system of claim 9, wherein said data is a voice over IP (VoIP) data flow.

13. The system of claim 9, wherein said delay value represents a performance level of an entire node.

14. The system of claim 9, wherein said value represents a performance level of an individual link.

15. A computer readable product embodied on a computer readable medium for routing data from a source node to a destination node in a mobile ad-hoc network (MANET) comprising a plurality of mobile nodes and a plurality of links between nodes of said MANET, the product comprising:
first computer executable instructions for determining desired service requirements for said data;
second computer executable instructions for determining a quantitative value for each link at a node where the link originates in said MANET;
third computer executable instructions for broadcasting an advertisement for each of said links in said MANET by each of said nodes, said advertisement including said value;
fourth computer executable instructions for composing a routing table at each of said nodes based upon said value; and
fifth computer executable instructions for forwarding packets from said source node to said destination node in accordance with said routing table such that a route selected from said routing tables satisfies said desired service requirements.

16. The product of claim 15, wherein said desired service requirements comprise bandwidth, delay and packet loss probability.

17. The product of claim 15, wherein said value comprises available bandwidth, delay and signal quality at each node.

18. The product of claim 15, wherein said data is a voice over IP (VoIP) data flow.

19. The product of claim 15, wherein said delay value represents a performance level of an entire node.

20. The product of claim 15, wherein said value represents a performance level of an individual link.
